(19) United States
(12) Patent Application Publication
(10) Pub. No.: US 2011/0203537 A1
(43) Pub. Date: Aug. 25, 2011

(54) Device and Method for the Electrothermal-Chemical Gasification of Biomass

(75) Inventor: Michael Prestel, Sindelfingen (DE)

(73) Assignee: AEN Autarke Energie GmbH, Sindelfingen (DE)

(21) Appl. No.: 12/991,244

(22) PCT Filed: Mar. 11, 2009
(86) PCT No.: PCT/EP2009/001745

§ 371 Date: Jan. 28, 2011

(30) Foreign Application Priority Data
May 7, 2008 (DE) 10 2008 023 822.8

(51) Int. Cl. F02B 43/00; C10B 1/00; C10J 1/20

(52) U.S. Cl. 123/3; 48/89; 48/116; 48/197 R; 48/219

(57) ABSTRACT

A device for extracting fuels from biomass while adding electrical energy, comprising the a gasifier for gasifying the biomass while adding electrical energy to a gas mixture, a reformer for reforming the gas mixture obtained from the gasification, a gas scrubber for scrubbing the reformed gas mixture, the device further comprising a heating system upstream of and/or in the region of the reformer for additionally heating the gas mixture obtained from the gasification and a first recirculation device so that the reformed or scrubbed gas mixture can optionally be recirculated to the gasifier or supplied to at least one correspondingly downstream component of the device, the first recirculation device providing a recirculation loop for the reformed or scrubbed gas mixture and the recirculation loop comprising at least the gasifier and the reformer.

The specification relates to a device and a method for the electrothermal-chemical gasification of biomass, in particular for the electrothermal-chemical gasification of biomass for obtaining hydrogen or fuel, and for providing a gas mixture for a combustion engine from biomass while adding electric energy.

There are several well-known energy conversion devices and facilities such as nuclear power plants, coal-fired power plants or solar power plants and wind power plants for making energy usable to humans. In particular, an energy conversion with the aid of wind power plants, solar power plants or facilities for extracting energy from water power suffers from the drawback that they are only able to provide electric energy under specific external conditions. This means that a sufficiently strong wind, a sufficient solar irradiation or a suitable water quantity has to be available. A generation of electric energy can thus not be provided continuously or on demand but depends on external influences.

There is thus a need of being able to store in particular electric energy at the time of its generation so as to be able to use it on demand.

Several embodiments of energy storages are known in the prior art.

An object of the invention is to provide a device and/or a method for storing energy so as to be able to use it at a later time. The device and the method for storing energy should furthermore have a high total efficiency.

Therefore, a device for gasifying biomass while adding electric energy having the following components is provided:

a gasifier for gasifying the biomass while adding electric energy to a gas mixture,
a reformer for reforming the gas mixture obtained by the gasification,
a gas scrubber for scrubbing the reformed gas mixture,
wherein the device further comprises a heater upstream and/or in the area of the reformer for additionally heating the gas mixture obtained by the gasification, and a first recirculation device so that the reformed or the scrubbed gas mixture is optionally recirculated into the gasifier or supplied to at least one respective following component of the device, wherein the first recirculation device provides a recirculation loop for the reformed or scrubbed gas mixture and the recirculation loop comprises the gasifier and the reformer.

The gas mixture obtained in the gasification is commonly also called “synthesis gas”.

According to the described embodiment, biomass is gasified in the gasifier by means of electric energy. For this purpose, conventional devices for gasifying biomass provide a so-called allothermic pyrolysis of biomass in which the heat used in the process is to be externally provided. It has to be generated expensively and provided to the biomass, e.g. by heat exchangers, for the pyrolysis. An alternative solution is a so-called autothermic energy supply, in which e.g. oxygen for gasifying the biomass is to be supplied to the latter. However, this has the drawback that the gas mixture generated by the gasification has to be enriched with additional oxygen which subsequently has to be expensively removed or which causes a higher CO₂ content in the gas mixture and thus leads to a lower calorific value of the gas mixture if it remains in the generated gas mixture. In contrast, the proposed gasification using electric energy does not require a supply of oxygen so that the generated gas mixture has a high purity and thus a high calorific value. Furthermore, an almost complete gasification of the biomass can be achieved in this way.

The reformed gas mixture subsequently obtained in the reformer can be recirculated into the gasifier by means of the described recirculation device before a further processing in the gas scrubber so that the already reformed gas mixture passes at least the gasifier and the reformer at least once again. This recirculation cycle can of course be repeated an arbitrary number of times so that the gas mixture circulates several times in this recirculation loop.

In this manner, certain undesired components of the gas mixture such as long-chained carbon compounds or hydrocarbon compounds can be broken down to a higher degree so that their content in the reformed gas mixture can be reduced. Furthermore, it is possible to configure the recirculation device in such a manner that the reformed gas mixture is initially scrubbed in the gas scrubber and only then recirculated via a correspondingly configured recirculation device into the gasifier as a scrubbed gas mixture. This means that the recirculation loop comprises, apart from the gasifier and the reformer, at least the gas scrubber. In this manner, a scrubbing of the respective reformed gas mixture is provided in each recirculation cycle.

If it is desired that the reformed gas mixture or the scrubbed gas mixture is not recirculated into the gasifier in respective embodiments, the respective gas mixture can be supplied to at least the respective downstream component of the device. If the recirculation device is configured for recirculating the reformed gas mixture, the reformed gas mixture is provided to the following gas mixture if it is desired that the reformed gas mixture does not pass through the recirculation device. However, if the recirculation device is configured for recirculating the scrubbed gas mixture into the gasifier, the scrubbed gas mixture is conducted to a component of the device following the gas scrubber if it is not desired that the scrubbed gas mixture passes through the recirculation device.

The device can furthermore be configured so that an internal pressure of the device builds up automatically by the gasification.

According to another embodiment, the device can be operated continuously and/or discontinuously, wherein in a discontinuous operation of the device, the reformed or the scrubbed gas mixture is at least once recirculated before it is supplied to the at least one respective downstream component.

As already described above, the recirculation of the reformed or of the scrubbed gas mixture can be performed merely optionally. This means that there is an option of recirculating the respective gas mixture via the recirculation device into the gasifier or instead of supplying it to the respective downstream component. There is also the option of performing a merely partial recirculation. This means that only a portion of the respective gas mixture is recirculated via the recirculation device to the gasifier and that the remaining portion is conducted to the respective downstream component of the device. Correspondingly, there is no complete recirculation of the respective gas mixture via the recirculation device, but the gas mixture is at least partially conducted directly to the respective downstream component of the device so that the operation of the device is called a “continuous operation”. In this case, the device can continuously be provided with biomass for performing a continuous gasification. The individual components of the device thus perform a steady or continuous operation and are passed only once (with the exception of the partially recirculated portion of the gas mixture).

However, if a complete recirculation of the respective gas mixture into the gasifier or the recirculation loop is provided, the device cannot be operated continuously. Correspondingly, this operation is called a chargewise or discontinuous operation. This means that only a certain amount of biomass is supplied to the gasifier for gasification. The gas mixture obtained in the gasification in this process is recirculated into the gasifier according to the embodiment of the device either as a reformed gas mixture after passing the reformer or as a scrubbed gas mixture after passing the gas scrubber by means of the recirculation device, as described above. The recirculation loop established in this case represents a closed circuit in which the respective gas mixture is recirculated. It is thus possible to determine the dwell time of the respective gas mixture in the gasifier not only via a volume flow of the gas mixture. Additionally, the composition of the gas mixture can rather be influenced by a number of cycles of the gas mixture in the recirculation loop, and in particular the above-mentioned long-chained hydrocarbon compounds can be broken down to a high degree by repeated cycles so that a high purity of the respective gas mixture can be achieved.

According to another embodiment, the device comprises a reactor for the generation of hydrogen from the scrubbed gas mixture by means of a so-called “hydrogen-shift-reaction”. The device thus provides a reactor arranged downstream the gas scrubber which is configured to generate hydrogen from the scrubbed gas mixture by means of the above-mentioned reaction. The hydrogen generated in this process can be separated by means of a corresponding separation device from a remaining residual gas. As separation devices, molecular sieves or a so-called pressure change adsorption method can be used, for example. The hydrogen generated in this process can be stored relatively easily so that the energy stored in the hydrogen can easily be obtained on demand. For example, electric energy or electric current can be provided on demand by means of a fuel cell operated with the hydrogen.

Alternatively to the described reactor, the device can be coupled with a combustion engine, wherein the scrubbed gas mixture can be used for the operation of the combustion engine. This means that the scrubbed gas mixture is conducted to the combustion engine and is used there in the framework of a so-called cogeneration. The combustion engine can be configured as a cogeneration unit or as a gas turbine for the generation of electric current and heat, for example.

According to another alternative embodiment, the device can be configured for obtaining fuel, and it can comprise the following components for this purpose:

a catalytic converter for performing a catalytic reaction for obtaining a reaction mixture from the scrubbed gas mixture, and
a separator for separating fuel from the reaction mixture.

Furthermore, the device can comprise devices for supplying hydrogen for hydrogenating the biomass or the gas mixture obtained by the gasification and represent a closed system in an operating state.

Therefore, a device for extracting fuel from biomass while adding electric energy having the following components is provided:

a gasifier for gasifying the biomass while adding electric energy to a gas mixture, wherein optionally a simultaneous hydrogenation of the heated biomass or the gas mixture obtained by the gasification can be carried out using hydrogen,
a reformer for reforming the gas mixture obtained by the gasification,
a gas scrubber for scrubbing the reformed gas mixture,
a catalytic converter for carrying out a catalytic reaction for obtaining a reaction mixture from the scrubbed gas mixture, and
a separator for separating the fuel from the reaction mixture. The device further comprises devices for supplying hydrogen for hydrogenating the biomass or the gas mixture obtained by the gasification and represents a closed system in an operating state.

As already described above, the device further comprises a first recirculation device so that the reformed or the scrubbed gas mixture can optionally either be recirculated into the gasifier or supplied to the respective downstream component of the device, i.e. either to the gas scrubber or to the catalytic converter, wherein the first recirculation device provides a recirculation loop for the reformed or the scrubbed gas mixture and the recirculation loop comprises at least the gasifier and the reformer.

A device for extracting fuel from a synthesis gas by means of a catalytic reaction in a catalytic converter and a separation in a separator is described in the patent application filed by the applicant of the present application “Vorrichtung and Verfahren zur Treibstoffsynthese”, for example.

It should be noted that the operation of the described device and the underlying method will be illustrated in the following merely as an example with respect to alcohol which is obtained as fuel from the biomass. Of course, the disclosed descriptions of the respective components of the device always also apply to corresponding components of the embodiments for extracting hydrogen and for the coupling of the device with a combustion engine insofar as the corresponding components are also provided in these cases. This in particular applies to all components including at least the gas scrubber as well as to all method steps provided in connection with these components up to the transfer of the scrubbed gas mixture to a downstream component of the device. Instead of alcohol, other fuels such as diesel or gasoline can be generated. In this case, the material of the used catalyst potentially has to be adapted.

The optional simultaneous hydrogenation can be performed before the gasification of the biomass for hydrogenating the biomass or for enhancing its H₂ content or later in the reforming process as was described above. Pure hydrogen as well as hydrogen containing compounds can be used. As an example, also methanol as a hydrogen containing compound and water can be added for gasifying the biomass. Accordingly, the device can comprise a device for supplying hydrogen containing compounds to the biomass for its hydrogenation and/or a device for supplying water which is optional as well. The supply of water can in particular be provided if the biomass is too dry so that it has to be provided with water.

For a better understanding of the processes occurring in the gasification, subsequently the reaction equations for a vapor reformation of methane and water occurring here a.) and a synthesis gas generation b.) by gasification of glucose (C₆H₁₂O₆) from biomass as well as a total reaction c.) of both reactions a.) and b.) are illustrated by way of examples. Here, the synthesis gas generation in b.) suffers from a lack of hydrogen (b: 6 H₂) which can be met by the methane produced in the vapor reformation a.) of methane, for example.

6CH₄+6H₂O→6CO+18H₂→6CH₃OH+6H₂ a.)

C₆H₁₂O₆→6CO+6H₂+(6H₂) [symbol] →6CH₃OH b.)

6CH₄+6H₂O+C₆H₁₂O₆→12CH₃OH c.)

An alternative way of providing hydrogen, for example by means of electrolysis, is subsequently discussed in further detail. Moreover, a photovoltaic device for generating so-called solar hydrogen for generating and supplying hydrogen can be provided.

According to another embodiment, the first recirculation device can comprise an electric preheater for preheating the reformed or scrubbed gas mixture to be recirculated into the gasifier. In this manner, a potential cooling of the reformed or scrubbed gas mixture after the reformation in the reformer or after the scrubbing in the gas mixture can be reduced before it is again supplied to the gasifier, and the temperature of the reformed or scrubbed gas mixture to be supplied can thus be increased for a repeated gasification.

Furthermore, the first recirculation device can comprise, according to the embodiment of the device, an outlet valve for optionally conducting the reformed or the scrubbed gas mixture out of the recirculation loop to the at least one respective downstream component of the device. If a recirculation of the reformed or scrubbed gas mixture is completed, the reformed or scrubbed gas mixture can be allowed to exit the recirculation loop by means of the outlet valve and supplied to the downstream components of the device. The device can thus be operated discontinuously. This means that the reformed gas mixture is recirculated in the recirculation loop and only passed on to the device after a defined event has occurred. The number of recirculation cycles of the reformed or scrubbed gas mixture until it is outlet via the outlet valve can be made dependent on different criteria. Thus, the outlet valve can be opened after a defined time period, for example, and the reformed or scrubbed gas mixture can be passed on to the downstream components only after this event. In the same manner, sensors measuring the amount of individual components of the gas mixture can be arranged in the recirculation loop. If a defined amount of specific components of the gas mixture has been reached, the reformed or scrubbed gas mixture can be allowed to exit the recirculation loop via the outlet valve. For this purpose, a probe can be provided, for example, which can determine a residual methane amount or a residual tar amount in the reformed or scrubbed gas mixture.

Of course, the reformed or scrubbed gas mixture can as well be passed on immediately after having passed once through the gasifier and the reformer so that the reformed or scrubbed gas mixture is not introduced into the recirculation loop, but is directly passed on to the down-stream components of the device via the outlet valve. In this case, a continuous operation of the device occurs, as also described above.

The first recirculation device can further comprise a recirculation pump for the operation of the recirculation loop. By means of this recirculation pump, the reformed or scrubbed gas mixture can thus be conducted into the gasifier. A piston pump or even a recirculation blower can be used as a recirculation pump, for example.

According to an embodiment, the device comprises means for hydrogen electrolysis for supplying hydrogen in order to hydrogenate the biomass or the gas mixture obtained by the gasification. The device can thus be configured so that hydrogen for the above described hydrogenation is provided. Of course, the hydrogen can alternatively be provided by other sources such as a device for generating solar hydrogen. If means for hydrogen electrolysis are provided, the electric current used for carrying out the electrolysis can be obtained not only from conventional current sources but also from regenerative energy conversion facilities such as wind power plants and photovoltaic power plants.

Furthermore, the device can comprise at least one component of a group of components consisting of catalytic converters, filters, coolers, condensate separators, heat exchangers and molecular sieves.

The described device can furthermore include at least one caustic bath provided for a gas scrubbing operation for removing halogen compounds, for example. With the aid of this caustic bath, in particular fluorine and chlorine (HCl and HF) can be extracted from a respective gas mixture. As a caustic solution, sodium hydroxide NaOH can be used, for example, so that salt and water are obtained in a reaction with HCl according to the following reaction equation:

NaOH+HCl→NaCl+H₂O

The described caustic bath can in particular be configured as an autonomous component of the device or as a part of the gas scrubber.

Furthermore, the invention provides a method for gasifying biomass while adding electric energy, comprising the following steps:

gasifying the biomass to a gas mixture in a gasifier while adding electric energy,
hydrogenating and reforming the gas mixture obtained by the gasification,
scrubbing the reformed gas mixture,
wherein the method comprises an optional at least partial recirculation of the reformed or the scrubbed gas mixture into the gasifier at least for a repeated gasification of the reformed or the scrubbed gas mixture in a recirculation loop and an optional supply of the reformed or the scrubbed gas mixture to at least one respective downstream component of the device, and
wherein the method further comprises a step of heating the gas mixture obtained by the gasification before and/or in the reforming step by means of electric energy and/or by local combustion of oxygen.

Furthermore, the method can comprise an immediate supply of the reformed or the scrubbed gas mixture to at least one respective downstream component of the device or an at least once occurring passage of the recirculation loop with a subsequent output to the at least one respective down-stream component. As already described above, a continuous or discontinuous operation of the device is enabled in this manner.

The method can further comprise the following step:

generating hydrogen from the scrubbed gas mixture by means of a “hydrogen-shift-reaction”.

Alternatively to this step, the method can further comprise the following step:

using the scrubbed gas mixture for operating a combustion engine.

As another alternative to the two steps of generating hydrogen by means of the hydrogen-shift-reaction and using the scrubbed gas mixture for operating the combustion engine, the method for extracting fuel from biomass while adding electric energy can further include the following steps:

obtaining a reaction mixture from the scrubbed gas mixture by a catalytic reaction in a catalytic converter and separating the fuel from the reaction mixture in a separator.

Consequently, this provides a method for extracting fuel such as alcohol from biomass while adding electric energy, comprising the following steps:

gasifying the biomass to a gas mixture in a gasifier,
reforming the gas mixture obtained by the gasification with water vapor and hydrogenating with hydrogen,
scrubbing the reformed gas mixture,
optionally at least partially recirculating the reformed or the scrubbed gas mixture into the gasifier at least for a repeated gasification of the reformed or scrubbed gas mixture in a recirculation loop,
obtaining a reaction mixture from the scrubbed gas mixture by a catalytic reaction in a catalytic converter, and
separating the fuel from the reaction mixture in a separator.

Furthermore, the method can comprise the following step:

electrically preheating the reformed or scrubbed gas mixture to be recirculated before another gasification cycle in the gasifier. In this manner, a so-called cracking or splitting in particular of long-chained hydrocarbon compounds can be achieved. Herein, in particular a so-called thermal cracking by means of heating and a hydrocracking by means of hydrogenating can be differentiated. In both methods, long-chained compounds are broken down into short-chained molecules.

The method can further comprise a step of hydrogen electrolysis for hydrogenating biomass or the gas mixture obtained by the gasification. This hydrogen electrolysis can take place at a pressure corresponding to a local system pressure existing at the inlet location, or else a densification of the generated hydrogen is possible or necessary.

The method may additionally comprise a step of the group including the following steps:

a filtering step,
a cooling step,
a condensate separation step, and
at least one step of passing through a heat exchanger.

Furthermore, the method can additionally comprise at least one of the following steps:
a) Heating the gas mixture obtained by the gasification by means of electric energy and/or by local combustion of oxygen. For this purpose, a heating device which is operated electrically, for example, can be provided which additionally heats the gas mixture obtained by the gasification. Alternatively, the heating device can be operated with gas in order to additionally heat the gas mixture, or oxygen can be blown into the gas mixture for its local combustion.
b) Hydrogenating a gas mixture with hydrogen and subsequent reforming the gas mixture with water vapor. With this step, an arbitrary gas mixture can be provided with hydrogen at an arbitrary location of the device. This can be performed in the gasifier, for example, by hydrogenating the gas mixture obtained by the gasification, for example, and cause a splitting of long-chained hydrocarbon compounds (CH compounds such as coke).
c) Introducing the reformed or scrubbed gas mixture into a catalytic converter. For generating catalytic reactions, during and/or after the step of reforming, for example, the gas mixture can be introduced into a catalytic converter. The catalytic converter can be made of a suitable catalytic material such as cobalt or platinum which is arranged as a charge in a heat exchanger or behind it.
d) Drying the biomass before the gasification step with the aid of the gas mixture obtained by the gasification or of the reformed gas mixture by means of a counterflow heat exchanger. Here, the biomass is dried by the high temperature of the gas mixture heated by the gasification or reformation before it is supplied to the gasifier or before the gasification.
e) Using the water vapor obtained in the drying step for the reforming step. In this step, water vapor generated in the above described step of drying the biomass is used for the reformation by a water gas reaction at higher temperatures.
f) Recirculating at least a portion of the gas mixture remaining after the separation step into the gasifier. Hereby, the remaining gas mixture can be recirculated into the gasifier, for example, for performing another hydrogenation and reformation step, so that the remaining gas mixture can be subjected again to the above described method or device.
g) Separating components of the gas mixture remaining after the separation step by suitable molecular sieves. By means of these molecular sieves individual components of the remaining gas mixture such as nitrogen can be removed from the gas mixture before the remaining gas mixture is again supplied to the gasifier, as illustrated. For this purpose, the molecular sieves in the device can be arranged in a principal flow so that the portion of the remaining gas mixture recirculated in the direction of the gasifier is entirely passed through the molecular sieves. Alternatively, the molecular sieves can be arranged in an auxiliary flow so that only a partial separation occurs in the auxiliary flow and another portion of the recirculated gas mixture is directly conducted to the gasifier via a principal flow. The described device can correspondingly provide second recirculation devices so that a gas mixture can be recirculated from the separator into the gasifier and supplied to the gasifier, respectively, wherein the second recirculation devices have principal flow ducts and/or auxiliary flow ducts.
h) Burning a portion of the gas mixture remaining after the separation step. Alternatively or in addition to the described separation, at least a portion of the remaining gas mixture can be burnt and thus removed so that an enrichment with inert gas components such as N₂ can be avoided.

According to another embodiment, the method further comprises at least one step of a group including the following steps: a real gasification, a gas-vapor-reformation, a coke carbonization, a coke hydrogenation, a tar condensation, an electrolysis and a fuel synthesis such as an alcohol synthesis.

The device and the method described above thus enable the generation of fuel from biomass while adding electric energy, wherein in addition to the fuel, heat is liberated. The following disclosures, as initially mentioned, only refer to alcohol as fuel for illustrative purposes. Thus, this enables the conversion of electric energy from electric current into chemical energy which is stored in the form of alcohol and can be stored relatively easily. Electric energy which is present under favorable conditions such as suitable wind conditions, sufficient solar irradiation or in another form can thus be stored in the form of alcohol.

The biomass used in this process serves as a carbon provider and can furthermore be used to enhance the efficiency. The described method allows a conversion of the carbon (C) to an alcohol such as methanol (CH₃OH) so that a conversion to CO₂ which was common in prior methods can be prevented.

The conversion and storage of electric energy in the form of alcohol allows a simple and efficient storage because alcohol can usually be obtained in the liquid state and stored in tanks. The energy stored in the alcohol can be reused or retrieved in several manners. For example, alcohol can be used as fuel or it can be converted into heat or electric current.

Apart from a simple storage, storing the alcohol in tanks enables a provision of the alcohol on demand and thus of the energy stored in it. The alcohol is available independently of external influences and can furthermore easily be transported.

Waste heat which is generated in the described electrothermal-chemical gasification of biomass for storing energy in alcohol can be made usable for heating purposes or for the generation of industrial water, for example. In this way, a relatively high total efficiency of the described method or the described device of 90-100%, for example, can be achieved using the waste heat or a so-called caloric value exploitation.

The described device for carrying out the described method can be configured as a small decentral device so that it is usable in households or single-family homes, for example. In principle, the device can be scaled arbitrarily so that larger devices or facilities can as well be realized which can be used centrally.

The described method allows an addition of the energy amounts of electric current and biomass and allows a high total efficiency by the use of the waste heat.

The use of biomass allows a diverse biomass exploitation and thus a large raw-material base. Substantially the entire carbon of the biomass can be converted into alcohol. In this process, substantially no carbon dioxide CO₂ is generated. CO₂ is only liberated in a subsequent use of the alcohol, e.g. in the combustion of the alcohol. However, in this process only as much CO₂ is liberated as has been absorbed in the production of the biomass, e.g. in plants. Only the use of the biomass enables the storage of the electric energy of the electric current in liquid form, for example, as alcohol. The electric current used for this purpose can be spatially separated from the alcohol production. For example, wind power plants or solar power plants can be installed at favorable locations, and the generated electric current can be transported to locations for the production of alcohol at which a sufficient amount of biomass is present. The devices for the production of alcohol can of course as well be installed directly adjacent to the facilities generating electric current such as wind power plants or solar power plants, for example.

By means of the energy storage, the energy can thus be provided on demand even in times of low wind strengths or during night time. In principle, almost the entire carbon present in the biomass can be converted to alcohol, wherein substantially no CO₂ is generated. The device uses electric energy from electric current for generating or obtaining alcohol. This allows in particular a use of so-called surplus powers which in case of the described energy conversion or power generation plants usually only occur at times of low load or demand.

As already described above, the device can comprise a gasifier for the gasification of the biomass to a gas mixture or a synthesis gas. Furthermore, the device can comprise a gas scrubber for scrubbing the gas mixture or for scrubbing the gas and/or an electrolysis device, wherein in the gas scrubber among others carbon compounds can be separated from the gas mixture. The electrolysis device uses electric current for producing hydrogen by means of electrolysis. Furthermore, alcohol, e.g. methanol (CH₃OH), can be generated from the gas mixture, e.g. the synthesis gas and hydrogen (H₂), in a separator of the device by means of an alcohol synthesis. The alcohol is correspondingly extracted and can be stored in tanks. The waste heat of the described device is usable for heating purposes or the generation of industrial water, for example, or it can be extracted in suitable means as process heat.

As disclosed above, the described device for extracting alcohol can use one or several (partial) methods from a group of methods. This group comprises an ideal gasification, a real gasification, a gas-vapor-reformation, a coke carbonization, a coke hydrogenation, a tar condensation, an electrolysis and a methanol synthesis.

The above described method for extracting alcohol can furthermore comprise the following steps: heating the biomass by means of electric current or gasifying the biomass to a gas mixture and cracking of carbon-hydrogen compounds (CH compounds) which are included in the gas mixture by means of the so-called steam reforming process or gas-vapor reforming process. The gas mixture generated and simultaneously heated in the gasification can be passed for a heat recirculation through counterflow heat exchangers and thus be used for heating the generated gas mixture as well as the biomass. In this manner, only energy losses have to be compensated by electric energy of the used electric current, and otherwise an energy supply can be realized by recirculating the heat.

Furthermore, a so-called intermittent operation can be used for burning coke with oxygen O₂ and water H₂O. The gas mixture or the synthesis gas obtained in the described method includes carbon monoxide (CO), carbon dioxide (CO₂) and hydrogen (H₂). By means of a subsequent methanol synthesis, alcohol can be obtained from the gas mixture or synthesis gas.

The described gas mixture (if not otherwise specified) is to be regarded as the gasified gas mixture generated in the gasification, the components or the composition of which can vary by respective reactions in the individual steps or in the use of the individual (partial) methods.

The described method can further include a multi-stage gas processing consisting of several steps. In the gasification of the biomass, a heating by means of the electric energy of the electric current as well as an additional heating of the gas mixture by means of counterflow heat exchangers occur. Furthermore, the gas processing can include, as mentioned above, a gas-water vapor-reformation, a coke carbonization with oxygen (O₂) and a tar-condensate-water vapor-reformation. A separation of potentially generated ashes which is generated in particular in the gasification of the biomass can be carried out by means of a preseparation in an ash tray having grates. The device can furthermore include electrostatic filters configured for burning ashes. Furthermore, a use of fine-tissue filters is possible. In order to avoid a contamination or clogging of filters, so-called regeneration cycles can be provided in a control of the device. Furthermore, a so-called purge cycle can be used for the alcohol synthesis such as the methanol synthesis.

By means of the described method, a potential separation of long-chained carbon compounds, in particular of hydrocarbon compounds from the biomass, such as tar precipitations, can be avoided because they are present in a gaseous state at high temperatures. They only condense in the cooling process and can lead to congestions. However, by suitable recirculation devices, the carbon compounds or the tar containing substances of the gas mixture can pass the device or portions of the device several times until the tar or tar residues have completely been degraded. This can be achieved by a so-called cracking or splitting the long-chained carbon compounds.

The above described regeneration cycle can for instance include a burn-off of the device by a short-time heating of the entire system or the entire device or of portions of the device. The described separation of the ashes can occur by means of electrostatic filters, for example, which can be cleaned by regeneration. Furthermore, a burn-off of filter surfaces in ash boxes is possible. Electrostatic filters, in contrast to fine filters such as fine-tissue filters, do not require any service apart from emptying the ash boxes. Of course, a use of the fine filters or fine-tissue filters which can be cleaned or changed on demand is also possible.

The catalyst used in the device allows a long lifetime if biomass with a low sulfur content is used. However, if biomass having a high sulfur content is used, a cyclic replacement of the catalyst may be necessary. Furthermore, a sulfur filter in the form of a desulfurization stage can be used. The latter can be provided in the form of a zinc oxide layer (ZnO) on a suitable carrier. In the zinc oxide layer, for example H₂S (hydrogen sulfide) can be converted by means of ZnO to ZnS (zinc sulfide) and H₂O (water), wherein the described reaction can occur in a temperature range between 200 and 400° C., for example. A condensate removal which may be required in the device can be carried out by means of a separation with water and condensate, for example.

In principle, any organic materials can be used as biomass. These include in particular wood, wood chips, pellets as well as domestic trash, paper, cardboard, straw, grass and green waste. Algae, plankton and agricultural wastes can also be used. PVC-free plastics or shredder waste can also be used as biomass. Here, the biomass can be provided in solid form or also in liquid form. Liquid biomass is for instance known under the name “bio slurry” and offers the advantage of a considerably reduced volume with respect to biomass in solid form. The above list only serves as an example and should not be regarded as complete, however.

The efficiency of the described method or the described device strongly depends on the used biomass. In small and decentral devices, higher-rate biomass can therefore be used in order to provide a sufficient efficiency, for example, whereas in large devices almost any biomass even with a lower efficiency can be used.

As described above, the device can be scaled differently so that different performance stages can be achieved. The lower the direct conversion efficiency, the more economical are small decentral systems with heat exploitation. The higher the efficiency, the more practical are large devices.

At this stage, explicit reference should be made again to the initial remark that the generation of alcohol as fuel is described merely as an example and that other fuels apart from alcohol can be generated with the described method and the described device as well. In the same way, the descriptions of the respective components and method steps disclosed in connection with the extraction of alcohol also apply to the embodiments for extracting hydrogen and the coupling of the device with a combustion engine insofar as the corresponding components and method steps can also be provided in these cases.

Other advantages and modifications of the invention will be understood with reference to the specification and the accompanying drawings.

It should be understood that the above mentioned features and the features to be explained below can not only be used in the respective indicated combination but also in other combinations or individually without leaving the scope of the present invention.

The invention is schematically illustrated in the drawings with respect to embodiments and will be described in further detail below with reference to the drawings.

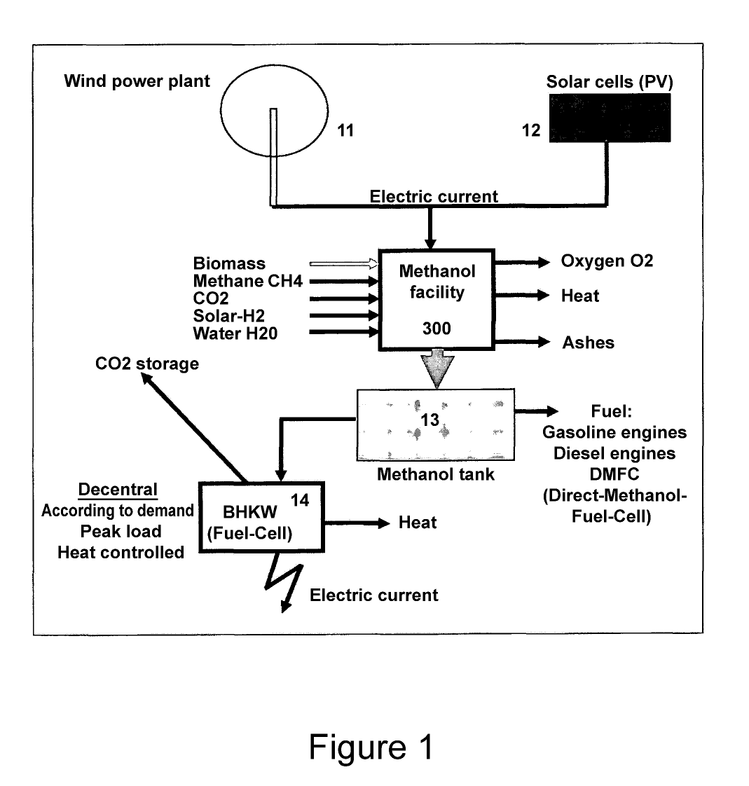

FIG. 1 shows a schematic illustration of a system for extracting alcohol from electric current and biomass.

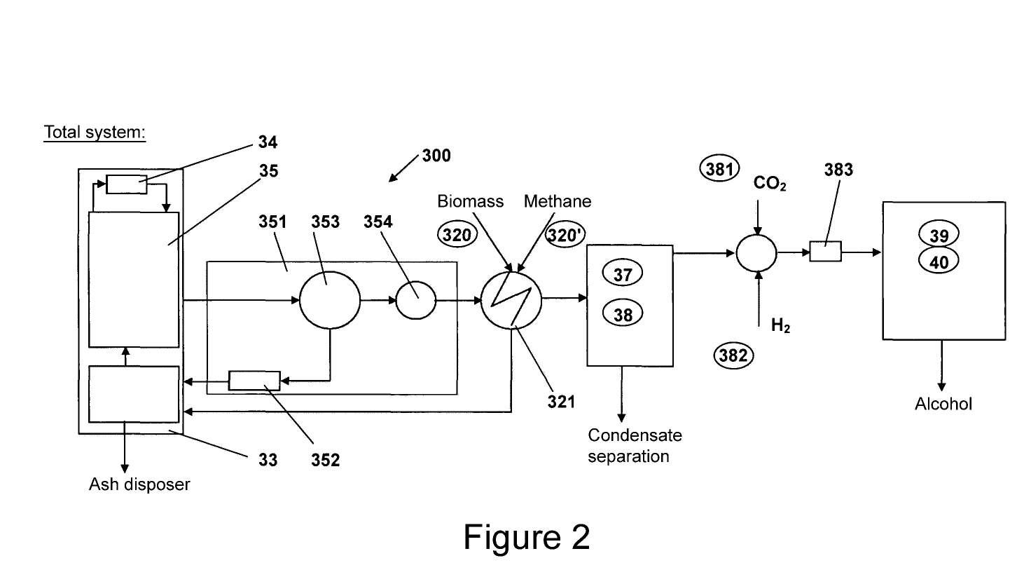

FIG. 2 shows a schematic illustration of a device for extracting alcohol from biomass while adding electric energy from electric current.

FIG. 1 shows a schematic illustration of a system for extracting fuel from biomass with the aid of electric current using alcohol and methanol, respectively, as an example. Thus, the system comprises a device 300 for extracting methanol into which the biomass for generating the methanol is introduced and which is described in detail in the following FIG. 2. Aside from the biomass, additional methane and/or H₂ for hydrogenating the biomass can optionally be introduced. In this case, the H₂ can be generated either by hydrogen electrolysis (if corresponding devices are provided for this purpose) or be supplied by a corresponding facility (not illustrated) in the form of solar hydrogen (solar-H₂), for example. Apart from the biomass, CO₂ can moreover be introduced instead of or in addition to the biomass for the operation of the device 300. Moreover, water can optionally be used for gasifying the biomass and for a vapor reformation of methane and water, respectively. The electric current used for the operation of the device 300 can be derived from conventional sources or from regenerative sources such as wind power plants 11 and/or photovoltaic power plants 12. The device 300 produces inorganic components of the supplied materials in the form of ash as well as heat which is generated in the chemical reactions occurring in the device and the desired fuel in the form of methanol. If the device 300 provides devices for hydrogen electrolysis, oxygen can also be produced. The generated methanol is extracted from the device 300 and introduced into a tank 13 for storage purposes from which it can be withdrawn on demand as fuel for multiple purposes. Apart from a merely illustrative use in correspondingly adapted gasoline and diesel engines, a use in corresponding fuel cells such as direct methanol fuel cells (DMFC) as well as in a cogeneration unit 14 is feasible. In the conversion to electric current, heat and CO₂ and potentially water are also generated at these stages.

FIG. 2 shows a schematic illustration of an embodiment of a device 300 for extracting alcohol from biomass while adding electric energy from electric current. For this purpose, the device 300 comprises a feeder 320 for the biomass or from a biomass container (not illustrated). The feeder can be configured for feeding biomass in solid form, or it can comprise pressure pipes for introducing liquid biomass. The biomass is supplied via the feeder 320 to a gasifier 33 in order to perform a gasification. Optionally, a feeder 320′ for hydrogen or hydrogen containing compounds such as methane for hydrogenating the biomass or enhancing its H₂ content can also be provided in the feeder 320 of the biomass. This obviates the need to perform an electrolysis for the generation of hydrogen in order to provide H₂.

The illustrated embodiment further comprises a second heat exchanger 321 in the region of the feeder 320 so as to be able to heat the supplied biomass already before it is fed to the gasifier. This will be described in further detail below.

In the gasifier 33, the biomass is gasified to a gas mixture while adding electric energy. For this purpose, the gasifier 33 is heated by means of electric energy, and the biomass is burnt or gasified by pyrolysis. Any ashes can be removed by suitable devices (not illustrated). The gasified gas mixture generated in the gasification ascends in a housing of the gasifier 33. At the upper end of the housing of the gasifier 33, a heating device 34 is arranged in which the gas mixture generated in the gasification is further heated electrically and introduced from the heating device 34 into a heat exchanger 35. Alternatively, the heating device 34 can include an afterheating with oxygen (not illustrated) so that oxygen is supplied and burnt for generating heat. The heat exchanger 35 comprises a reformer for reforming the gas mixture generated in the gasification and conducts the reformed gas mixture within the housing of the gasifier 33 in a direction opposite to the ascending gas mixture generated in the gasification. Subsequently, the reformed gas mixture is conducted out of the housing of the gasifier 33. The heat exchanger 35 is designed so that it conducts the reformed gas mixture in a direction opposite to the ascending gas mixture generated in the gasification so that it heats the ascending gas mixture generated in the gasification with the help of the reformed gas mixture which has been further heated in the reforming process.

Furthermore, a charge with a catalytic function can be provided in the heat exchanger 35 and in corresponding conduits of the heat exchanger 35, respectively, so that a catalytic converter can additionally be provided. This charge can be cobalt, platinum or other suitable catalytically acting materials, for example.

After having passed through the heat exchanger 35 or the reformer, the reformed gas mixture can be introduced into a first recirculation device 351. By means of this first recirculation device 351, the reformed gas mixture can be recirculated into the gasifier 33 or supplied to the gasifier 33. The first recirculation device 351 thus provides a recirculation loop for the reformed gas mixture, wherein the recirculation loop comprises the gasifier 33, the heating device 34 and the heat exchanger 35 or the reformer. Thus, the reformed gas mixture obtained in the reformer can be recirculated into the gasifier 33 before it is further processed in a downstream gas scrubber 37 so that the already reformed gas mixture passes through the components of the recirculation loop once again. Of course, this recirculation loop can be repeated with an arbitrary number of recirculation cycles so that the gas mixture in this recirculation loop repeatedly circulates.

Furthermore, the recirculation device 351 comprises a preheater 352 for preheating or heating the reformed gas mixture before it is again introduced into the gasifier 33.

For the operation of the recirculation loop and the recirculation of the reformed gas mixture into the gasifier 33, the first recirculation device 351 includes a recirculation pump 353. If it is desired to remove the reformed gas mixture from the described recirculation loop, it is conducted via an outlet valve 354 into another second heat exchanger 321 providing for a heat exchange between the reformed gas mixture and the biomass transported in the feeder 32. For this purpose, the second heat exchanger 321 can be arranged in the region of the feeder 320, for example. The reformed gas mixture is subsequently conducted into a gas scrubber 37 for scrubbing the reformed gas mixture. In this process, carbon containing compounds, in particular hydrocarbon containing compounds (CH) such as tar are extracted from the reformed gas mixture. These extracted carbon containing compounds can be resupplied by suitable devices (not illustrated) to the biomass and pass the gasifier 33, the heating device 34 and the heat exchanger 35 having a reformer in another passage, and they can thereby be removed. In this process, the usually long-chained carbon containing compounds are split by the so-called cracking. The device for resupplying carbon containing compounds is not shown in FIG. 2, however.

The scrubbed gas mixture generated in the gas scrubber 37 can optionally be filtered in a filter 38 which can be configured as a fine-tissue filter or an electrostatic filter, for example. The gas mixture filtered or scrubbed in this process is now conducted to a catalytic converter 39 for extracting alcohol from the scrubbed or filtered gas mixture by a catalytic reaction. Subsequently, the alcohol is separated in a separator 40 and extracted into a tank (not illustrated either). Because in the catalytic reaction in a catalytic converter only a portion of the gas mixture reacts, the device can be configured so that the gas mixture remaining after the separator 40 passes the catalytic converter 39 several times in order to react remaining residues or components of the gas mixture as well. For this purpose, the remaining gas mixture is again supplied to the catalytic converter 39 after passing the separator 40. The remaining gas mixture is admixed to the filtered or scrubbed gas mixture supplied by the gas scrubber 37 or the filter 38, and they are both introduced into the catalytic converter 39.

The illustrated embodiment provides merely optional devices for supplying CO₂ 381 and hydrogen (H₂) 382 to the scrubbed or filtered gas mixture. They allow an enrichment of the respective amounts of these components in the gas mixture for a modification and adaptation of the composition of the scrubbed or filtered gas mixture for the subsequent synthesis in the catalytic converter 39 or the separator 40.

A supply of CO₂ can occur from a separate storage (not illustrated), for example. If the gas mixture is supplied with CO₂, the demand of biomass can simultaneously be lowered, or a lower carbon content of the biomass can be compensated. Furthermore, the device 300 can be operated with an arbitrary combination of biomass, methane, hydrogen and CO₂.

For the generation of the supplied hydrogen, the device can further comprise a device (not illustrated) for generating hydrogen such as a device for hydrogen electrolysis or a solar hydrogen plant, and it can be coupled with it.

The hydrogen can also be introduced into the feeder 32 and/or the gasifier 33 and/or in the region of the separator 40, for example.

Furthermore, a densifier 383 can be optionally provided for the supply of CO₂ and H₂ in order to pressurize the supplied gases at least to a local system pressure of the device 300.

Furthermore, the device 30 is configured so that the entire device 30 represents a closed system. A configuration of the entire device as a closed system in particular allows a direct supply of the biomass from the biomass container if it is integrated into the entire system as well and subject to the respective internal pressure of the gasifier 33 as well. A connection of the biomass container 31 via a pressure valve is not required in this case.

The biomass container can be configured so that it contains or stores a certain amount of the biomass for an operation of the facility of several hours or an entire day, for example. Only when the container is empty, the internal pressure of at least the gasifier and thus also the biomass container is lowered to the atmospheric pressure, and the filling of the biomass container can again be performed. Subsequently, the gasification is restarted, whereby the required system pressure or internal pressure in the gasifier 33 or the biomass container is automatically established.

By means of a so-called “purge gas recirculation” (not illustrated either), at least a portion of the remaining gas mixture can be recirculated into the gasifier 33 for gasification after the illustrated alcohol separation in the separator 40. In this manner, gases or components of the remaining gas mixture such as methane can again be converted to CO and H₂ in the reformer. An enrichment of nitrogen and other inert gases or gas components can be avoided by a cyclical or continuous partial separation from the recirculated remaining gas mixture (so-called circulation gas or purge gas). From this so-called “purge gas” either the undesired portion or the corresponding molecules can be separated by molecular sieves (not illustrated) or the purge gas is burnt directly. The heat generated in this process can be used for the described method or the described device.

1-26. (canceled)

27. Device for gasifying biomass while adding electric energy, comprising:
a gasifier for gasifying the biomass while adding electric energy to a gas mixture;
a reformer for reforming the gas mixture obtained by the gasification;
a gas scrubber for scrubbing the reformed gas mixture;
the device further comprising a heating system upstream and/or in the region of the reformer for additionally heating the gas mixture obtained by the gasification, and a first recirculation device so that the reformed or scrubbed gas mixture can optionally be recirculated to the gasifier or supplied to at least one corresponding downstream component of the device, the first recirculation device providing a recirculation loop for the reformed or scrubbed gas mixture, and the recirculation loop comprising at least the gasifier (33) and the reformer.

28. Device according to claim 27, wherein the device is continuously and/or discontinuously operable, wherein in a discontinuous operation of the device, the reformed or scrubbed gas mixture is recirculated at least once before it is supplied to the at least one respective downstream component.

29. Device according to claim 27, and further comprising a reactor for generating hydrogen from the scrubbed gas mixture by means of a so-called “hydrogen-shift-reaction”.

30. Device according to claim 27, wherein the device is coupled with a combustion engine, wherein the scrubbed gas mixture can be used for operating the combustion engine.

31. Device according to claim 27, wherein the device is configured for obtaining fuel and further comprises:
a catalytic converter for performing a catalytic reaction for extracting a reaction mixture from the scrubbed gas mixture; and
a separator for separating a fuel from the reaction mixture.

32. Device according to claim 27, and further comprising devices for supplying hydrogen for hydrogenating the biomass or the gas mixture obtained by the gasification, and representing a closed system in an operating state.

33. Device according to claim 27, wherein the device comprises a device for supplying hydrogen containing compounds to the biomass for its hydrogenation.

34. Device according to claim 27, wherein the first recirculation device comprises an electric preheater for preheating the reformed or scrubbed gas mixture to be recirculated into the gasifier.

35. Device according to claim 27, wherein the first recirculation device comprises an outlet valve for optionally outputting the reformed or the scrubbed gas mixture from the recirculation loop to the at least one respective downstream component of the device.

36. Device according to claim 27, wherein the first recirculation device comprises a recirculation pump for operating the recirculation loop.

37. Device according to claim 27, wherein the device comprises means for hydrogen electrolysis for providing hydrogen for hydrogenating the biomass or the gas mixture obtained by the gasification.

38. Device according to claim 27, and further comprising at least one component of a group of components consisting of catalytic converters, filters, coolers, condensate separators, heat exchangers and molecular sieves.

39. Device according to claim 31, and further comprising second recirculation devices so that a gas mixture from the separator is recirculated into the gasifier or supplied to the gasifier, wherein the second recirculation devices have principal flow ducts and/or auxiliary flow ducts.

40. Device according to claim 27, and further comprising a device for supplying CO₂.

41. Device according to claim 31, wherein alcohol is obtained as fuel from the biomass.

42. Method for gasifying biomass while adding electric energy, comprising:
gasifying the biomass to a gas mixture in a gasifier while adding electric energy;
reforming and hydrogenating the gas mixture obtained by the gasification;
scrubbing the reformed gas mixture;
wherein the method comprises an optional at least partial recirculation of the reformed or the scrubbed gas mixture into the gasifier at least for another gasification of the reformed or the scrubbed gas mixture in a recirculation loop and an optional supply of the reformed or the scrubbed gas mixture to at least one respective downstream component of the device; and
wherein the method further comprises a step of heating the gas mixture obtained by the gasification before and/or in the reforming step by means of electric energy and/or by local combustion of oxygen.

43. Method according to claim 42, comprising an immediate supply of the reformed or the scrubbed gas mixture to at least one respective downstream component of the device or an at least once occurring passage of the recirculation loop with a subsequent output to the at least one respective downstream component.

44. Method according to claim 42, and further comprising:
generating hydrogen from the scrubbed gas mixture by means of a “hydrogen-shift-reaction”.

45. Method according to claim 42, and further comprising:
using the scrubbed gas mixture for operating a combustion engine.

46. Method according to claim 42, wherein the method for extracting fuel from biomass while adding electric energy further comprises:
obtaining a reaction mixture from the scrubbed gas mixture by a catalytic reaction in a catalytic converter and separating the fuel from the reaction mixture in a separator.

47. Method according to claim 42, and further comprising at least one of the following steps:
electrically preheating the reformed or scrubbed gas mixture to be recirculated before another gasification in the gasifier;
hydrogenating a gas mixture with hydrogen and subsequently reforming the gas mixture with water vapor;
drying the biomass before the gasification step with the aid of the gas mixture obtained by the gasification or of the reformed gas mixture, by means of a counterflow heat exchanger;
using the water vapor obtained in the drying step for the reforming step.

48. Method according to claim 42, and further comprising a step of hydrogen electrolysis for hydrogenating biomass or the gas mixture obtained by the gasification.

49. Method according to claim 42, and further comprising at least one step of the group including the following steps:
a filtering step;
a cooling step;
a condensate separation step; and
at least one step of passing through a heat exchanger.

50. Method according to claim 43, wherein the group of steps further includes at least one of the following steps:
introducing the reformed or the scrubbed gas mixture into a catalytic converter;
recirculating at least a portion of the gas mixture remaining after the separation step into the gasifier;
separating components of the gas mixture remaining after the separation step by suitable molecular sieves; and
burning at least a portion of the gas mixture remaining after the separation step.

51. Method according to claim 46, and further comprising at least one step of the group including the following steps: a real gasification, a gas-vapor-reformation, a coke carbonization, a coke hydrogenation, a tar condensation, an electrolysis and a fuel synthesis.

52. Method according to claim 46, wherein alcohol is obtained as fuel from the biomass.
